(19) United States
(12) Patent Application Publication
(10) Pub. No.: US 2018/0114528 A1
(43) Pub. Date: Apr. 26, 2018

(54) SYSTEMS AND METHODS FOR GENERIC FLEXIBLE DIALOGUE MANAGEMENT

(71) Applicant: IPsoft Incorporated, New York, NY (US)

(72) Inventors: Ugan YASAVUR, Jersey City, NJ (US); Reza AMINI, Secaucus, NJ (US); Jorge TRAVIESO, New York, NY (US)

(21) Appl. No.: 15/429,987

(22) Filed: Feb. 10, 2017

Related U.S. Application Data
(60) Provisional application No. 62/413,087, filed on Oct. 26, 2016.

(51) Int. Cl. G10L 15/22; G10L 15/18

(52) U.S. Cl. CPC G10L 15/22; G10L 2015/223; G10L 15/1822; G10L 15/1815

(57) ABSTRACT

A method for a virtual agent to process natural language utterances from a user is provided. The method can include receiving natural language utterance from the user, determining a type of the utterance, and based on the utterance type, determining an action for the virtual agent to take. The virtual agent can execute the action.

### CROSS REFERENCE TO RELATED APPLICATIONS

This application claims priority of and benefit to U.S. provisional patent application No. 62/413,087, filed on Oct. 26, 2016, the entire contents of which are incorporated herein by reference in their entirety.

### FIELD OF THE INVENTION

The invention relates generally to dialogue management systems. In particular, the invention relates to methods for a dialogue management system to handle multiple types of dialogues.

### BACKGROUND OF THE INVENTION

Currently dialogue management systems are typically responsible for managing state and/or flow of a dialogue between a user and a computer (e.g., a virtual agent, computer answering system, etc. . . . ). Current dialogue management systems typically use processes (e.g., Markov decision processes or flowcharts) to, for example, represent dialogue rules and/or use state based representations, which can require enumeration of all possible system states and/or can require a scenario designer for the processes to estimate all possible ramifications that might appear in the dialogue. Some current solutions for these difficulties are typically not re-usable and/or can require a commercially unrealistic amount of effort to maintain.

These current dialogue systems typically have disadvantages. For example, in current dialogue systems the dialogues can be very rigid (e.g., require a linear flow of actions) therefore the output from the computer is not typical of natural language conversations (e.g., output of the computer may have nothing to do with a user utterance). Some current dialogue systems deliver rigid behavior due to, for example, in specific states they typically expect one specific input, which can be the input based on what the dialogue system has asked the user, and/or current dialogue systems can ignore any other response received. For example, assume a user wants to order a pizza and the dialogue system asks for toppings and that the user provides all required details (e.g. toppings, delivery, crust type) to order pizza except one of them (e.g. sauce). Assume the user asks what sauces are available. Current dialogue systems may not know how to handle the question, and will likely not respond to the question.

Current dialogue systems can require that for each new task, the dialogue interaction steps typically are designed from scratch, thus reusability can be impossible/very limited. Other difficulties with current dialogue systems are that it can be difficult to inject semantics that might change flow of the conversations; current systems can operate single task and/or solve one task at a time, they typically do not have consolidated knowledge representation of topics they are trained for; and/or conversation state representation can fall short of sufficiently representing intricacies of the dialogue.

### SUMMARY OF THE INVENTION

Some advantages of the technology can include the ability to handle semantically rich task-based conversations flexibly where configuring the system for new tasks can require very little configuration compared to alternative approaches. Another advantage can include the ability to inject semantics to a dialogue state representation. Another advantage is the ability to handle input types that current systems typically do not. Referring to the pizza example, if the user asks what sauces are available, the dialogue system of the current invention can handle the request, e.g., via a sub-dialogue.

Some advantages of the invention can include improved handling of dialogue state representation, ease in creating new scenarios, and/or handling multiple tasks. Another advantage of the invention can include reducing and/or eliminating effort of a dialogue scenario designer in creating dialogue routines, due to, for example, common dialogue routines that can include slots that have varying associated routes based on a data type of the slot (e.g., single value, multi-value, and/or Boolean). Another advantage of the invention can include reducing and/or eliminating explicit elaboration of dialogue states and/or creation of flow charts due to, for example, an ability to infer states automatically. Another advantage of the invention can include an ability to handle multiple tasks at one time due to, for example, the reduction/elimination of state-based and/or flow chart based dialogues. Some advantages of the invention can include an ability to deploy new dialogue systems quickly and/or reduce maintenance requirements.

Another advantage of the invention can include an ability to allow for injecting semantics due to, for example, a most probably response evaluation of responses that are not expected slot values. Another advantage of the invention can include an ability to provide a more realistic conversation flow to a user.

In one aspect, the invention involves a method for a virtual agent to process natural language utterances from a user. The method can involve receiving the natural language utterance from the user. The method can also involve determining a utterance type, the utterance type comprises a goal of the user, a piece of information needed to satisfy a goal, or a dialogue act. The method can also involve determining an action of one or more actions for the virtual agent based on the utterance type, the one or more actions comprising search for one or more processes, fill a slot within one or more processes, execute a process, ask for input from the user, output a statement to the user, or any combination thereof. The method can also involve executing by the virtual agent the action.

In some embodiments, determining the action also involves for an utterance type of a goal and all information needed to satisfy the goal has been received, then the action for the virtual agent is execute a behavior, and for an utterance type of a goal and all information needed to satisfy the goal has not been received, then the action for the virtual agent is ask for input from the user.

In some embodiments, determining the action also involves for an utterance type of a piece of information and the utterance is in response to the virtual agent asking for input from the user, then the action is fill one or more slots, and for an utterance type of a piece of information and the utterance is not in response to the virtual agent asking for input from the user, then the action is search for one or more processes and fill a slot within each process of the one or more processes.

In some embodiments, searching for the one or more processes also involves identifying all processes from a plurality of processes that have a slot that matches the piece of information.

In some embodiments, the method also involves if a number of the one or more processes identified by the search is less than or equal to three then transmitting a multi-choice question, otherwise, transmitting a request to clarify the piece of information to a user.

In some embodiments, in determining the action also involves for an utterance type of a dialogue act, then the action is ask for input from the user, fill a slot, escalate to a human agent or output a statement to the user.

In some embodiments, the action of fill one or more slots involves determining a confidence level for the piece of information based on whether or not the slot requires a prior context to be identified.

In some embodiments, if the natural language utterance is a plurality of goals, then determining one goal of the plurality of goals to solve first based on user input, types of goals of the plurality of goals, or any combination thereof.

### BRIEF DESCRIPTION OF THE DRAWINGS

Non-limiting examples of embodiments of the disclosure are described below with reference to figures attached hereto that are listed following this paragraph. Dimensions of features shown in the figures are chosen for convenience and clarity of presentation and are not necessarily shown to scale.

The subject matter regarded as the invention is particularly pointed out and distinctly claimed in the concluding portion of the specification. The invention, however, both as to organization and method of operation, together with objects, features and advantages thereof, can be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 is an example of a dialogue management system, according to an illustrative embodiment of the invention;

FIG. 2 is a flow chart for a virtual agent to process natural language utterances from a user, according to an illustrative embodiment of the invention;

FIG. 3 is a flow chart for determining one or more actions to execute by a virtual agent when an utterance type is a goal, according to an illustrative embodiment of the invention;

FIG. 4 is a flow chart for determining one or more actions to execute by a virtual agent when an utterance type is a piece of information, according to an illustrative embodiment of the invention; and

FIG. 5 is a flow chart for determining one or more actions to execute by a virtual agent when an utterance type is a dialogue act, according to an illustrative embodiment of the invention.

It will be appreciated that for simplicity and clarity of illustration, elements shown in the figures have not necessarily been drawn accurately or to scale. For example, the dimensions of some of the elements can be exaggerated relative to other elements for clarity, or several physical components can be included in one functional block or element. Further, where considered appropriate, reference numerals can be repeated among the figures to indicate corresponding or analogous elements.

### DETAILED DESCRIPTION

In general, a user can interact with a virtual agent. The interaction can include the user having a dialogue with the virtual agent. The dialogue can include utterances (e.g., any number of spoken words, statements and/or vocal sounds). The virtual agent can include a system to manage the dialogue.

The dialogue management system can drive the dialogue to, for example, help a user to reach goals and/or represent a state of the conversation. When the dialogue management system receives an utterance, the dialogue management system can determine a type of the utterance and determine an action for the virtual agent to take based on the type of the utterance. For example, for an utterance that is a piece of information needed to satisfy a goal, the dialogue management system can search all processes available for the processes (e.g., search for candidate processes) that have a slot for the piece of information. The dialogue management system can evaluate each utterance by a user and start multiple processes to be handled at the same time. For example, if the user indicates that they have two goals, to order a pizza and obtain directions to the movies, the dialogue management system can manage the two open processes in parallel to carry on a dialogue with the user to satisfy both goals.

In some scenarios, while the dialogue management system is attempting to fulfil a goal (e.g., has an open process pending), the user can input information that is not related to the open process, but can satisfy slots in other processes available in the system. The dialogue management system can open all processes having the slot, and attempt to clarify whether the user is interested in pursuing the corresponding goals.

The dialogue management system can evaluate whether enough slots for all open processes (e.g., goals) are satisfied for the dialogue management system to instruct the virtual agent to take corresponding actions of the process. If more than one process is satisfied, the dialogue management system can select one process by asking a clarifying question of the user to select between the more than one satisfied processes.

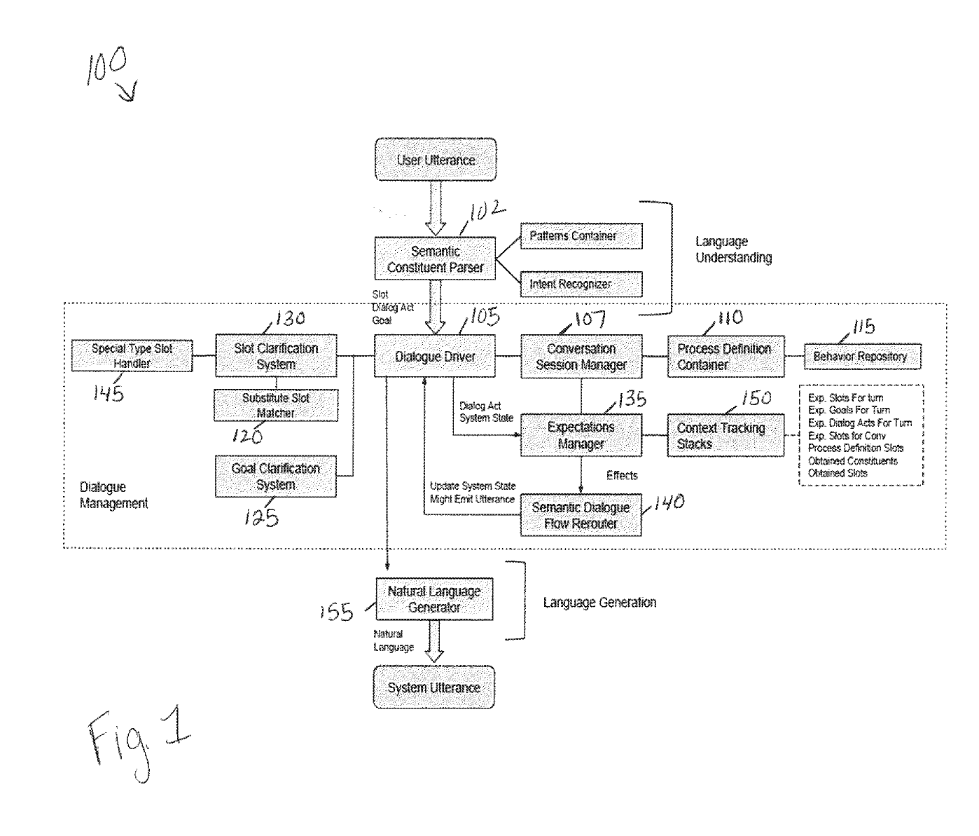

FIG. 1 is an example of a dialogue management system 100, according to an illustrative embodiment of the invention. The dialogue management system 100 can include sematic constituent parser module 102, a dialogue driver module 105, a conversation session manager module 107, a processor definition container module 110, a behavior repository module 115, a substitute slot machine module 120, a goal clarification system module 125, a slot clarification system module 130, an expectation manager module 135, a semantic dialogue flow re-router module 140, a special type slot handler module 145, context tracking stacks module 150 and/or a natural language generator module 155.

The semantic constituent parser 102 module can receive an utterance from a user. The utterance can be various utterance types. The utterance can be an utterance type of a goal (e.g., a goal of the user), an utterance type of a slot (e.g., a piece of information needed to satisfy a goal) and/or an utterance type of a dialogue act. In some embodiments, the utterance type can be abstract (e.g., a non-sequitur). In some embodiments, if the utterance type is abstract, a clarifying question can be asked of the user (e.g., a request for the user to state a goal).

The utterance can be determined to be a goal, slot and/or dialogue act by parsing the utterance and/or recognizing the intent of the utterance. The parsing can be based on identifying patterns in the utterance by comparing the utterance to pre-defined patterns. In some embodiments, parsing the utterance can be based on context free grammars, text classifiers and/or language understanding methods as is known in the art.

The sematic constituent parser 102 can communicate with a patterns container module 103 to receive the pre-defined patterns. Each utterance of the utterance can include more than one utterance type. For example, a user may utter “my goal is to order pizza and I would like cheese and pepperoni.” In this example, the utterance includes an utterance type of a goal—order a pizza, and two pieces of information towards fulfilling the goal—cheese and pepperoni.

The parsed utterance can be evaluated for intent by the intent recognizer module 104. The intent recognizer module 104 can determine intent of the parsed utterance. Continuing with the example above, the intent recognizer module 104 can determine that user intends to order pizza. The intent recognizer module 104 can determine intent via language understanding methods as are known in the art.

In some embodiments, the utterances are received from a human user. In various embodiments, the user is another virtual agent, another computing system and/or any system that is capable producing utterances. The utterance can be natural language utterances. The utterance can be received at any time during the dialogue with the virtual agent. The semantics constituent parser module 102 can communicate with the dialogue driver module 105. The semantics constituent parser module 102 can output the parsed and intent identified utterances to the dialogue driver module 105.

The dialogue driver module 105 can communicate with the expectation manager module 135, the slot clarification system module 130, the goal clarification system 125, the semantic dialogue flow re-router module 140, the conversation session manager module 107 and/or the natural language generator module 155. The dialogue driver module 105 can receive as input the utterance and/or the utterance type for the utterance from the semantics constituent parser module 102.

The dialogue driver module 105 can determine one or more dialogue acts for the virtual agent based on the expectation manager module 135 output, the slot clarification system module 130 output, the goal clarification system 125 output, the semantic dialogue flow re-router module 140 output and/or the conversation session manager module 107. The dialogue driver module 105 can transmit the one or more dialogue acts to the natural language generator module 155. The natural language generator module 155 can generate a natural language utterance for the virtual agent to output to the user. In some embodiments, the dialogue driver module 105 can transmit additional information related to the user and/or the dialogue act to the natural language generator module 155. For example, the dialogue driver module 105 can transmit a user's name to the natural language generator module 155, such that the natural language output to the user includes the user's name.

If the goal of the user is unknown, the dialogue driver module 105 can communicate with the goal clarification system module 125. The goal clarification system module 125 can provide questions to the dialogue driver module 105, to obtain clarification from the user regarding the goal. For example, assume that there is one slot identified and it is shared by three processes, and there are a total of twenty known processes in the system. The clarification can include questioning the user as to whether any of the three processes is the goal. In some embodiments, the user can state that two of the three processes is the goal. In these embodiments, a sub-routine to seek further clarification can be initiated. The sub-routine can guide the user to select only one of the two processes. In this manner, information about the process itself (e.g., goal of the process) can be used to obtain clarifying information.

If the goal of the user is known, but not all of the information to fulfill the goal has been received (e.g., all slots for a process have not been filled), the slot clarification system module 130 can provide questions to the dialogue driver module 105, to obtain clarification from the user regarding the information. In various embodiments, the user input is i) information to fill a slot that was asked for by the system; ii) an answer for a slot that was asked for by the system and additional information that satisfies another slot; iii) information that does not satisfy the slot that was asked for by the system but satisfies another slot; or iv) an irrelevant piece of information.

If the user input is information to fill a slot that was asked of the user then the slot clarification system module 130 may not provide questions to the dialogue driver module 105. If the user input is an answer for a slot that was asked of the user and additional information that satisfies another slot, then the slot clarification system module 130 can output one or more clarifying questions that attempt to fill empty slots in the open processes. If the user input is information that does not satisfy the slot that was asked of the user but satisfies another slot then the slot clarification system module 130 can output one or more clarifying questions that attempt to fill empty slots in the open processes. If the user input is an irrelevant piece of information, then the slot clarification system module 130 can output one or more clarifying questions that are repeats from previous questions and/or additional questions to fulfil slots in pending processes. In this manner, the slot clarification system module 130 can use any information received from the user that was not explicitly asked of by the user to satisfy slots in processes.

The slot clarification system module 130 can communicate with the substitute slot matcher module 120. If the utterance does not match a slot for the process, the substitute slot matcher module 120 can determine whether the utterance can be used to satisfy any slots of the process, even though the utterance may not be an exact match. For example, when utterances are received by the user, the utterances are parsed as described above. An utterance can be parsed in a manner that it does not appear to be the information that can satisfy the slot but it actually is. This scenario can arise, for example, because the grammars in the parser can include re-usable patterns, and the information to fulfil the slot is the same as the existing patterns (e.g., date related patterns, named entities, regular expression based patterns and/or numeric patterns). For example, if there is an invoice date slot with a custom grammar pattern “invoice date is [date],” if the user says the date only, the parser may only extract the date, not include “invoice date is” in the parsed text. In order to fulfil the invoice date slot, the system expects that the date will be accompanied by the term invoice. The substitute slot matcher module 120 can determine that date only can satisfy the invoice date slot.

The slot clarification system module 130 can communicate with the special type slot handler module 145. The special type slot handler module 145 can create a sub-dialogue (e.g., a sub-process to execute), in the event that a particular slot of a process can have multiple values. For example, toppings in a pizza, employees in a job application and/or countries that are visited customs control in airport are examples of slots that can have multi-values. In multi-value slot embodiments, the special type slot handler module 145 can identify the multi-value slot type and initiate a multi-turn sub-dialogue to attempt to obtain the multiple values from the user.

In some embodiments, the utterance is a piece of information that does not fill any slot in any pending process. In these embodiments, one or more processes that include a slot that corresponds to the piece of information can be started. In these embodiments, as more pieces of information are received by the user, slots in the one or more processes can be filled until at least one process of the one or more processes has less than a predetermined number of empty slots. The process of the one or more processes that has less than the predetermined number of empty slots can be selected as the process corresponding to the goal of the user, and the virtual agent can attempt to fill in the remaining slots of that particular process. In some embodiments, the predetermined number of empty slots can be a system input. In some embodiments, the predetermined number of empty slots is three. As is apparent to one of ordinary skill in the art, the predetermined number of empty slots can be any integer value.

The dialogue driver module 105 can transmit any, all or a subset of its information to the conversation session manager module 107. The conversation session manager module 107 can include all pending processes, process related parameters, context, and expectation related operations (e.g., expectation for the current turn and/or for the whole dialogue), such that when there are multiple processes pending, the conversation session manager module 107 includes them all. The information contained within the conversation session manager module 107 can be in stacks, as is known in the art.

The conversation session manager module 107 can communicate with the process definition container module 110. The conversation session manager module 107 can receive one or more processes from the process definition container module 110. The process definition container module 110 can store one or more processes. The one or more processes can correspond to goals of the user. For example, if the user indicates that the goal is to order a pizza, there can be one or more pizza ordering processes that if followed can achieve the goal of allowing the user to order a pizza. For example, the one or more processes can include a series of yes or no questions for the virtual agent to ask the user such that the virtual agent can instruct a chef of the user's order. In another example, the one or more processes can include a series of questions that request specific pieces of information of information from the user (e.g., topping types). In another example, the one or more processes can include yes or no questions and/or requests for specific pieces of information.

Each process of the one or more processes can be represented as a goal having one or more slots. Each slot can allow for a piece of information received by the user to be inserted. For example, a process can correspond to the goal of ordering a car part, and slots of car type, car year, part of the car, name of the user, address for delivery, and/or payment information. As is apparent to one of ordinary skill in the art, this process is for example purposes only and that any number of slots can be included in a process.

The one or more processes can be predetermined and stored in the process definition container module 110. The one or more processes can be directed towards any processes. The one or more processes can include steps for a virtual agent to take to have a natural language dialogue that is not in relation to the virtual agent executing a goal for the user. For example, the user may want to talk about the way he or she feels with the virtual agent.

The one or more processes can be input by a user, loaded from a database, specified by a user and programmed by an administrator or any combination thereof.

The process definition container module 110 can communicate with the behavior repository module 115. The process definition container module 110 can output an indicator that all the slots of a goal are satisfied and/or the process definition. The behavior repository module 110 can evaluate a satisfied goal and/or call another process.

The expectation manager module 135 can receive the one more utterances and/or a state of the dialogue from the dialogue driver module 105. The state of the dialogue can include i) if the goal is known; ii) whether or not a sub-routine is in the process of being executed; iii) whether or not a clarification is in the process of being obtained from the user; iv) slots that have been obtained; v) slots that are expected for a current turn; vi) expected dialogue acts for the current turn; vii) slots that are missing; and/or viii) slots to be asked for the current turn.

The expectation manager module 135 can also receive expected slot information from the conversation session manager module 107. The expectation manager module 135 can communicate with the context tracking stacks module 150. When the system asks a clarification question (e.g. a slot or goal fulfillment question), the expectation manager module 135 determine an expectation response (e.g., a slot, goal and/or dialogue act) for the clarification question. The expectation manager module can determine the expectation response by receiving an indication of missing information from the conversation session manager module 107.

The expectation manager module 135 can determine whether the utterance are expected. The determination can be based on whether the utterance are expected given a current state of the dialogue and/or whether the utterance are expected to reach a goal of the dialogue.

For example, if the user and the virtual agent are in the middle of a dialogue regarding a goal of ordering a pizza, if the virtual agent asks the user “which toppings would you like” and the user utters “I would like a whole wheat crust,” the expectation manager module 135 can determine that the utterance was not expected given that the current state of the dialogue is that the last question asked by the virtual agent was regarding toppings. Continuing with the same example, the expectation manager module 135 can determine that an utterance stating the type of crust the user would like is expected to reach the goal of ordering a pizza. The expectation manager module 135 can transmit the determination of whether the utterance are expected to the dialogue driver module 105.

If the expectation manager module 135 determines that the utterance were not expected, then the dialogue driver module 105 can re-ask the last question of the user (e.g., output the same dialogue act) or ignore the utterance and continue with the process (e.g., in the case that the user has indicated that they do not know the answer to the dialogue act).

In some embodiments, semantic dialogue flow re-router module 130 can determine whether to ignore one or more slots in the process. For example, if the user is asked a question intended to fill a slot and the user answers that she does not know, the sematic dialogue flow re-router module 130 can instruct the dialogue manager to ignore fulfilling that particular slot.

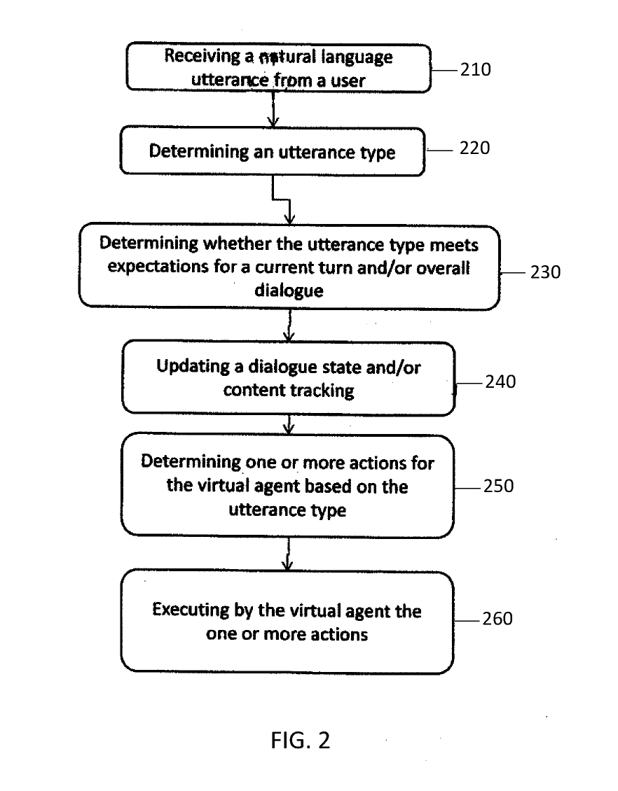

FIG. 2 is a flow chart for a virtual agent to process natural language utterances from a user, according to an illustrative embodiment of the invention. The method involves receiving the natural language utterance from the user (Step 210). The method can also involves determining an utterance type (Step 220) (e.g., as determined by the sematic constituent parser module 110, as described above in FIG. 1). The utterance type can include a goal of the user, a piece of information needed to satisfy a goal, or a dialogue act.

The method can also involve determining whether the utterance type meets expectations for a current turn and/or overall dialogue (Step 230) (e.g., as determined by the expectation manager module 135, described above in FIG. 1).

The method can also involve updating a dialogue state and/or content tracking (Step 240) (e.g., as updated by the dialogue driver module 105 and/or the context tracking stacks module 150, respectively, as described above in FIG. 1).

The method can also include determining one or more actions for the virtual agent based on the utterance type (Step 250) (e.g., as determined by the dialogue driver module 105, as described above in FIG. 1). The one or more actions can include search for one or more processes, fill a slot within a process, execute a behavior, ask for input from the user, output a statement to the user, or any combination thereof.

The method can also include executing by the virtual agent the one or more actions (Step 260). For example, assume that the process (e.g., goal of the user) is for ordering a pizza, and the one or more actions is execute a behavior. The virtual agent can execute the one or more actions by executing the behavior. In this example, the virtual agent can provide a pizza order to a chef.

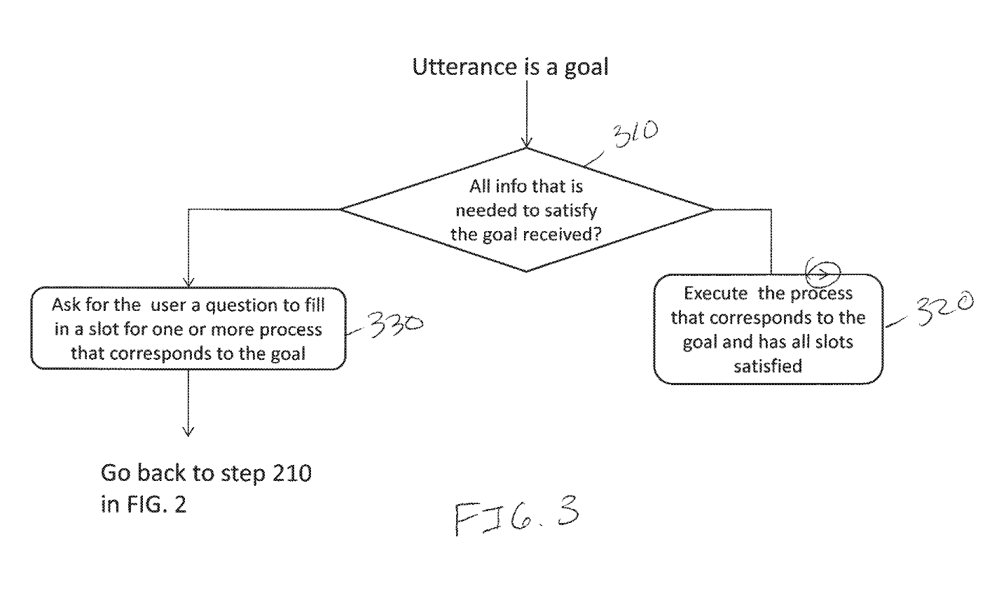

FIG. 3 is a flow chart for determining one or more actions to execute by a virtual agent when an utterance type is a goal, according to an illustrative embodiment of the invention. The method can involve determining if all of the information that is needed to satisfy the goal has been received (Step 310) (e.g., as determined by the slot clarification system module 130, as described above in FIG. 1). If all information needed to satisfy the goal has been received, then the method can involve setting the one or more actions for the virtual agent to execute a behavior (e.g., the process that correlates to the goal) (Step 320) (e.g., as set by the dialogue driver module 105, as described above in FIG. 1). If all information needed to satisfy the goal has not been received, then the method can involve setting the one or more actions for the virtual agent to ask for input from the user (Step 330) (e.g., as done by the dialogue driver module 105 and the natural language generator 155, as described above in FIG. 1), and proceeding back to Step 210 in the method of FIG. 2.

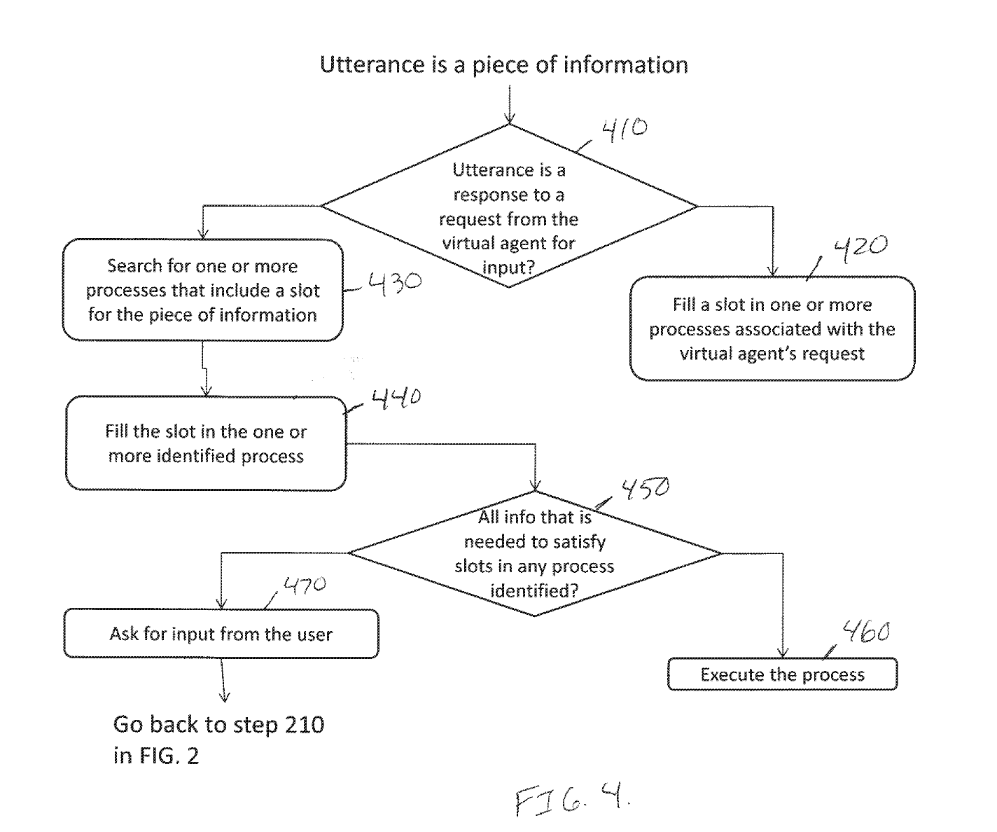

FIG. 4 is a flow chart for determining one or more actions to execute by a virtual agent when an utterance type is a piece of information, according to an illustrative embodiment of the invention. The method involves determining if the utterance is in response to a request from the virtual agent for input (Step 410) (e.g., as determined by the dialogue driver 110, as described above in FIG. 1). If the utterance is in response to a request from the virtual agent, then the method can involve filling a slot in the one or more processes corresponding to the one or more processes the virtual agent was attempting to fill a slot for (Step 420) (e.g., as filled by the slot clarification system module 130). If the utterance is not in response to a request from the virtual agent, then the method can involve searching for one or more processes that include a slot for the piece of information (Step 430) (e.g., searching as performed by the conversation session manager module 107 and the process definition container module 110, as described above in FIG. 1). The method can also involve filling the slot in the one more processes identified (Step 440) (e.g., as filled in the context tracking stacks module 150, as described above in FIG. 1). The method can also involve determining if all the information that is needed to satisfy the slots in any process is identified (Step 450) (e.g., as determined by the dialogue driver module 105 and the context tracking stacks module 150). If all of the information needed to satisfy the slots in one process is identified, then the method can involve executing behavior (Step 460). If all of the information needed to satisfy the slots in one process is not identified, then the method can involve asking for input form the user (Step 470) (e.g., as asked by the natural language generator module 155, as described above in FIG. 1), and going back to step 210 in the method of FIG. 2.

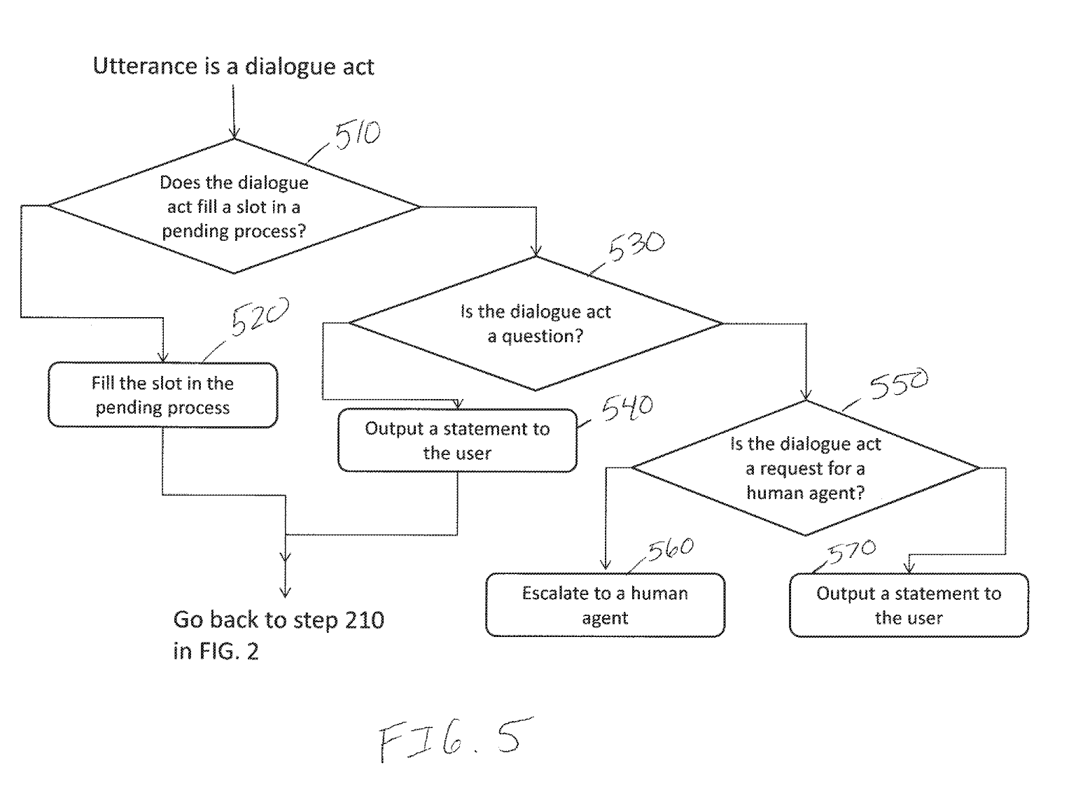

FIG. 5 is a flow chart for determining one or more actions to execute by a virtual agent when an utterance type is a dialogue act, according to an illustrative embodiment of the invention. The method can involve determining if the dialogue act fills a slot in a pending process (Step 510). If the dialogue act does fill a slot in the pending process, then the method can involve filling the slot in the pending process (Step 520), and going back to step 210 in the method of FIG. 2. If the dialogue act does not fill a slot in the pending process, then the method can involve determining if the dialogue act is a question (Step 530). If the dialogue act is a question, then the method can involve outputting a statement to the user (Step 540), and going back to step 210 in the method of FIG. 2. If the dialogue act is not a question, then the method can involve determining if the dialogue act is a request for a human agent (Step 550). If the dialogue act is a request for a human agent, then the method can involve escalating to a human agent (Step 560) (e.g., via the dialogue driver 105, as described above in FIG. 1). If the dialogue act is not a request for a human agent, then the method can involve outputting a statement to the user (Step 570).

In some embodiments, if the dialogue act is not a request for a human agent, then the method can involve determining whether the dialogue act is updating information already obtained, a user indication that information already received is incorrect and/or an indicator that the user no longer wants to continue with the current process. In these embodiments, the method can involve updating a slot in a process and/or ending the communication.

The above-described methods can be implemented in digital electronic circuitry, in computer hardware, firmware, and/or software. The implementation can be as a computer program product (e.g., a computer program tangibly embodied in an information carrier). The implementation can, for example, be in a machine-readable storage device for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by an apparatus and can be implemented as special purpose logic circuitry. The circuitry can, for example, be a FPGA (field programmable gate array) and/or an ASIC (application-specific integrated circuit). Modules, subroutines, and software agents can refer to portions of the computer program, the processor, the special circuitry, software, and/or hardware that implement that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computer having a display device, a transmitting device, and/or a computing device. The display device can be, for example, a cathode ray tube (CRT) and/or a liquid crystal display (LCD) monitor. The interaction with a user can be, for example, a display of information to the user and a keyboard and a pointing device (e.g., a mouse or a trackball) by which the user can provide input to the computer (e.g., interact with a user interface element). Other kinds of devices can be used to provide for interaction with a user. Other devices can be, for example, feedback provided to the user in any form of sensory feedback (e.g., visual feedback, auditory feedback, or tactile feedback). Input from the user can be, for example, received in any form, including acoustic, speech, and/or tactile input.

The computing device can include, for example, a computer, a computer with a browser device, a telephone, an IP phone, a mobile device (e.g., cellular phone, personal digital assistant (PDA) device, laptop computer, electronic mail device), and/or other communication devices. The computing device can be, for example, one or more computer servers. The computer servers can be, for example, part of a server farm. The browser device includes, for example, a computer (e.g., desktop computer, laptop computer, and tablet) with a World Wide Web browser (e.g., Microsoft® Internet Explorer® available from Microsoft Corporation, Chrome available from Google, Mozilla® Firefox available from Mozilla Corporation, Safari available from Apple). The mobile computing device includes, for example, a personal digital assistant (PDA).

Website and/or web pages can be provided, for example, through a network (e.g., Internet) using a web server. The web server can be, for example, a computer with a server module (e.g., Microsoft® Internet Information Services available from Microsoft Corporation, Apache Web Server available from Apache Software Foundation, Apache Tomcat Web Server available from Apache Software Foundation).

The storage module can be, for example, a random access memory (RAM) module, a read only memory (ROM) module, a computer hard drive, a memory card (e.g., universal serial bus (USB) flash drive, a secure digital (SD) flash card), a floppy disk, and/or any other data storage device. Information stored on a storage module can be maintained, for example, in a database (e.g., relational database system, flat database system) and/or any other logical information storage mechanism.

The above-described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other.

The above described networks can be implemented in a packet-based network, a circuit-based network, and/or a combination of a packet-based network and a circuit-based network. Packet-based networks can include, for example, the Internet, a carrier internet protocol (IP) network (e.g., local area network (LAN), wide area network (WAN), campus area network (CAN), metropolitan area network (MAN), home area network (HAN), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, Bluetooth®, code-division multiple access (CDMA) network, time division multiple access (TDMA) network, global system for mobile communications (GSM) network), and/or other circuit-based networks.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the foregoing detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention. Some features or elements described with respect to one embodiment can be combined with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes. Although embodiments of the invention are not limited in this regard, the terms “plurality” and “a plurality” as used herein can include, for example, “multiple” or “two or more”. The terms “plurality” or “a plurality” can be used throughout the specification to describe two or more components, devices, elements, units, parameters, or the like. The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

What is claimed is:

1. A method for a virtual agent to process natural language utterances from a user, the method comprising:
receiving a first natural language utterance from the user, wherein the first natural language utterance comprises a first goal or a first piece of information needed to satisfy the first goal, and the virtual agent has a first process in progress and wherein the natural language utterance does not satisfy one or more slots in the first process;
instantiating a second process from a plurality of processes for the virtual agent based on the first natural language utterance, wherein each process in the plurality of processes comprises a corresponding goal and a corresponding set of slots;
receiving a second natural language utterance from the user wherein the second natural language utterance comprises a second goal of the user, a second piece of information needed to satisfy the first goal or the second goal, or a first dialogue act;
determining which action of a plurality of actions for the virtual agent to take based on an utterance type of the second natural language utterance from the user, the plurality of actions comprising instantiate a third process, fill a slot within the first process, fill a slot within the second process, execute a behavior, ask for input from the user, and output a statement to the user; and
executing by the virtual agent the action.

2. The method of claim 1 wherein determining the action further comprises:
for the second natural language utterance of the second goal of the user, the utterance type is goal and:
if all information needed to satisfy the second goal has been received, then the action for the virtual agent is execute the behavior associated with the first goal, otherwise and
the action for the virtual agent is ask for input from the user.

3. The method of claim 1 wherein determining the action further comprises:
for the second natural language utterance of the second piece of information needed to satisfy the first goal or the second goal:
if the second natural language utterance is in response to the virtual agent asking for input from the user, then the action is fill one or more slots in the first process or the second process, otherwise
the action is instantiate one or more additional processes and fill a slot within each process of the one or more additional instantiated processes.

4. The method of claim 3 wherein instantiating the one or more additional processes further comprising identifying all processes from a plurality of processes that have a slot that matches the piece of information.

5. The method of claim 3 further comprising:
if a number of the one or more processes identified is less than or equal to three then transmitting a multi-choice question, otherwise, transmitting a request to clarify the piece of information to a user.

6. The method of claim 1 wherein determining the action further comprises:
for the second natural language utterance of the first dialogue act, the utterance type is dialogue act and the action is ask for input from the user, fill a slot, escalate to a human agent or output a statement to the user.

7-16. (canceled)

17. The method of claim 1, wherein the first natural language utterance further comprises one or more additional goals, one or more additional piece of information needed to satisfy the first goal, or any combination thereof.

18. The method of claim 17 wherein for the first natural language utterance of the first goal and the one or more additional goals, then instantiating the second process further comprises determining the second process for the first goal, and further comprising determining a corresponding additional process for each of the one or more additional goals.

19. The method of claim 17 wherein for the first natural language utterance of the first piece of information and the additional pieces of information, then instantiating the second process further comprises identifying one process of the plurality of processes that has a slot that the first piece of information can fill, and further comprising:
filing any slots in the first process or the second process that can be filled by the additional pieces of information, and for any of the additional pieces of information that cannot fill any slots in the first process or the second process, identifying all processes from the plurality of processes that have a corresponding slot for that the additional pieces of information that cannot fill any slots in the first process or the second process can fill, and instantiating all of the identified processes, such that all of instantiated processes operate in parallel.

20. (canceled)
